(19) United States
(12) Patent Application Publication
(10) Pub. No.: US 2023/0382687 A1
(43) Pub. Date: Nov. 30, 2023

(54) ELEVATOR SLIDING GUIDE SHOE, ELEVATOR CAR AND ELEVATOR COUNTERWEIGHT

(71) Applicant: Inventio AG, Hergiswil NW (CH)

(72) Inventors: Yuling Ding, Shanghai (CN); Guangsheng Wu, Shanghai (CN)

(21) Appl. No.: 18/249,747

(22) PCT Filed: Dec. 9, 2020
(86) PCT No.: PCT/CN2020/134934

§ 371 Date: Apr. 20, 2023

(30) Foreign Application Priority Data
Oct. 27, 2020 (CN) 202022414793.5

(51) Int. Cl. B66B 7/04; B66B 11/02; B66B 17/12

(52) U.S. Cl. CPC B66B 7/047; B66B 11/0226; B66B 17/12

(57) ABSTRACT

An elevator sliding guide shoe for an elevator car and an elevator counterweight includes: a pair of shoe liner brackets, adapted to be detachably mounted on a straight beam of an elevator car or an elevator counterweight; and a shoe liner, disposed between the pair of shoe liner brackets, including a pair of side walls and a bottom wall between the pair of side walls. The pair of side walls is detachably mounted on the pair of shoe liner brackets, respectively, such that the shoe liner is detachable by removing either one shoe liner bracket. The maintenance for the shoe liner can be completed without disassembling the entire elevator sliding guide shoe, especially for a hoistway with narrow space therein. It is very convenient to maintain and repair the split-type elevator sliding guide shoe, and it takes relatively less time in assembling and disassembling thereof.

### FIELD

Embodiments of the present disclosure generally relate to an elevator sliding guide shoe, and an elevator car and an elevator counterweight each including the elevator sliding guide shoe.

### BACKGROUND

In the prior art, an elevator sliding guide shoe is typically of an integral design. Therefore, during maintenance for an elevator, an entire set of elevator sliding guide shoes should be disassembled before a shoe liner of the elevator sliding guide shoes may be disassembled for maintenance. Each elevator sliding guide shoe is typically fixed to a straight beam of an elevator car or an elevator counterweight by 3-4 bolts. Therefore, it takes a relatively long time to disassemble during maintenance. In addition, when a distance between the car or counterweight and a hoistway wall is relatively small, a narrow space defined therebetween is adverse to an operation of disassembly tool(s), which brings great inconvenience to disassembly of the elevator sliding guide shoe, and also greatly influences quality in installation.

### SUMMARY

A purpose of the present disclosure is to solve at least one aspect of above problems and defects existing in the prior art.

According to one aspect of the present disclosure, there is provided an elevator sliding guide shoe, including: a pair of shoe liner brackets, adapted to be detachably mounted on a straight beam of an elevator car or an elevator counterweight of an elevator; and a shoe liner, disposed between the pair of shoe liner brackets, including a pair of side walls and a bottom wall between the pair of side walls. The pair of side walls of the shoe liner is detachably mounted on the pair of shoe liner brackets, respectively, such that the shoe liner is detachable merely by removing either one shoe liner bracket.

According to an exemplary embodiment of the present disclosure, at least one positioning foot is formed on each shoe liner bracket, and is bent and adapted to be inserted into a socket of the straight beam so as to position the respective shoe liner bracket and prevent the respective shoe liner bracket from rotating.

According to another exemplary embodiment of the present disclosure, two positioning feet are formed on each shoe liner bracket, with each positioning foot being formed at a respective one of an upper portion and a lower portion of each shoe liner respectively; and the two positioning feet are bent and adapted to be inserted into two sockets of the straight beam, respectively.

According to another exemplary embodiment of the present disclosure, each shoe liner bracket includes a base plate portion, used to be secured onto the straight beam, and the two positioning feet are formed on the upper portion and the lower portion of the base plate portion, respectively.

According to another exemplary embodiment of the present disclosure, each shoe liner bracket further includes a side plate portion perpendicular to the base plate portion, with a slot being formed on the side plate portion; and bump portions are formed on respective outer surfaces of the pair of side walls of the shoe liner, and are inserted into respective slots of the pair of shoe liner brackets so as to mount the shoe liner to the pair of shoe liner brackets.

According to another exemplary embodiment of the present disclosure, the elevator sliding guide shoe further includes a cushioning pad, with each of two side portions of the cushioning pad being clamped between respective side wall of the pair of side walls of the shoe liner and the side plate portion of respective shoe liner bracket of the pair of shoe liner brackets, respectively, and with a bottom portion of the cushioning pad being adapted to be clamped between the bottom wall of the shoe liner and the straight beam.

According to another exemplary embodiment of the present disclosure, each shoe liner bracket is secured to the straight beam by a single bolt.

According to another exemplary embodiment of the present disclosure, a first through-hole is formed on the base plate portion and a second through-hole is formed on the straight beam, both the first through-hole and the second through-hole allowing the bolt to pass through; the bolt passes through the first through-hole and the second through-hole and is threadedly connected with a screw nut so as to fixedly mount the respective shoe liner bracket onto the straight beam.

According to another aspect of the present disclosure, there is provided an elevator car, including the elevator sliding guide shoe as above, mounted on the straight beam of the elevator car, and adapted to slide along a car guide rail fixed on a hoistway wall of the elevator.

According to another aspect of the present disclosure, there is provided an elevator counterweight, including the elevator sliding guide shoe as above, mounted on the straight beam of the elevator counterweight, and is adapted to slide along a counterweight guide rail on a hoistway wall of the elevator.

In aforementioned exemplary embodiments according to the present disclosure, the elevator sliding guide shoe adopts a split-type design, including two separate shoe liner brackets, and a shoe liner which is detachably mounted to the two shoe liner brackets. Therefore, during maintenance, the shoe liner is detachable merely by removing either one shoe liner bracket. Therefore, in a process of maintenance for the elevator, the maintenance for the shoe liner may be completed without disassembling the entire elevator sliding guide shoe, especially for a hoistway with narrow space therein. It is very convenient to maintain and repair the elevator sliding guide shoe of the present disclosure which is of a split-type design, and it takes a relatively less time in assemble and disassemble thereof.

By a description of the present disclosure thereinafter, with reference to the attached drawings, other purposes and advantages of the present disclosure will become apparent and may assist in having a comprehensive understanding of the present disclosure.

### DESCRIPTION OF THE DRAWINGS

FIG. 1 illustrates a schematic view of an elevator sliding guide shoe installed on a straight beam according to an exemplary embodiment of the present disclosure;

FIG. 2 illustrates a stereoscopic schematic view of the elevator sliding guide shoe as illustrated in FIG. 1;

FIG. 3 illustrates a stereoscopic schematic view of the straight beam as illustrated in FIG. 1; and

FIG. 4 illustrates a stereoscopic schematic view of a shoe liner bracket of the elevator sliding guide shoe as illustrated in FIG. 2.

### DETAILED DESCRIPTION

Technical solutions of the present disclosure are further described in detail by the embodiments in view of attached drawings. In the specification, same or similar reference numerals indicate same or similar components. Following description of the implementations of the present disclosure with reference to the attached drawings is intended to explain an overall concept of the present disclosure, and should not be understood as a limitation of the present disclosure.

In addition, in the following detailed description, for the convenience in explanation, many specific details are set forth to provide a comprehensive understanding of the embodiments of the present disclosure. However, it is obvious that one or more embodiments may also be implemented without these specific details. In other cases, well-known structures and devices are embodied by illustrations so as to simplify the drawings.

According to an overall technical concept of the present disclosure, an elevator sliding guide shoe is provided, which includes: a pair of shoe liner brackets, adapted to be detachably mounted on a straight beam of an elevator car or an elevator counterweight of an elevator; and a shoe liner, disposed between the pair of shoe liner brackets, including a pair of side walls and a bottom wall between the pair of side walls. The pair of side walls of the shoe liner are detachably mounted on the pair of shoe liner brackets, respectively, such that the shoe liner is detachable merely by removing either one shoe liner bracket.

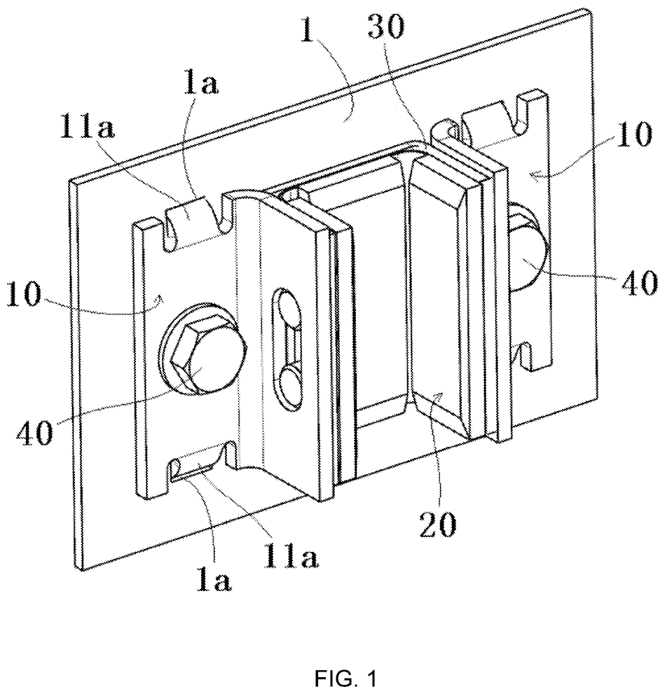

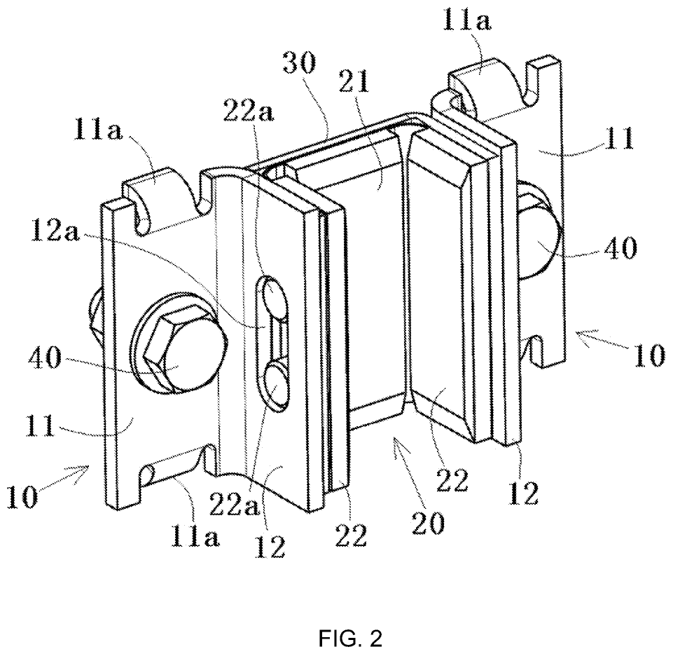

FIG. 1 illustrates a schematic view of an elevator sliding guide shoe installed on a straight beam according to an exemplary embodiment of the present disclosure. FIG. 2 illustrates a stereoscopic schematic view of the elevator sliding guide shoe as illustrated in FIG. 1.

As illustrated in FIG. 1 and FIG. 2, in the illustrated embodiment, the elevator sliding guide shoe mainly includes a pair of shoe liner brackets 10, a shoe liner 20 and a cushioning pad 30.

As illustrated in FIG. 1 and FIG. 2, in the illustrated embodiment, the pair of shoe liner brackets 10 is adapted to be detachably mounted on a straight beam 1 of an elevator car or an elevator counterweight of an elevator. The shoe liner 20 is disposed between the pair of shoe liner brackets 10. The shoe liner 20 includes a pair of side walls 22 and a bottom wall 21 between the pair of side walls 22. Each of two side portions of the cushioning pad 30 is clamped between respective side wall 22 of the pair of side walls 22 of the shoe liner and respective shoe liner bracket 10 of the pair of shoe liner brackets 10, respectively, and a bottom portion of the cushioning pad 30 is adapted to be clamped between the bottom wall 21 of the shoe liner 20 and the straight beam 1.

In an exemplary embodiment of the present disclosure, the shoe liner 20 may be made from high molecular polyethylene material, because the high molecular polyethylene material has characteristics of impact resistance, wear resistance, fine self-lubrication and excellent low-temperature performance. The cushioning pad 30 can be made from high elastic polyurethane material, because the high elastic polyurethane material may effectively reduce the impact and function to exhibit superior damping/cushioning effect.

As illustrated in FIG. 1 and FIG. 2, in the illustrated embodiment, the pair of side walls 22 of the shoe liner 20 is detachably mounted on the pair of shoe liner brackets 10, respectively, such that the shoe liner 20 is detachable merely by removing either one shoe liner bracket 10. Since the elevator sliding guide shoe of the present disclosure adopts a split-type design, then, during maintenance, the shoe liner 20 is detachable merely by removing either one shoe liner bracket 10. Therefore, in a process of maintenance for the elevator, the maintenance for the shoe liner may be completed without disassembling the entire elevator sliding guide shoe, especially for a hoistway with narrow space therein. It is very convenient to maintain and repair the elevator sliding guide shoe of the present disclosure which is of a split-type design, and it takes a relatively less time in assembling and disassembling thereof.

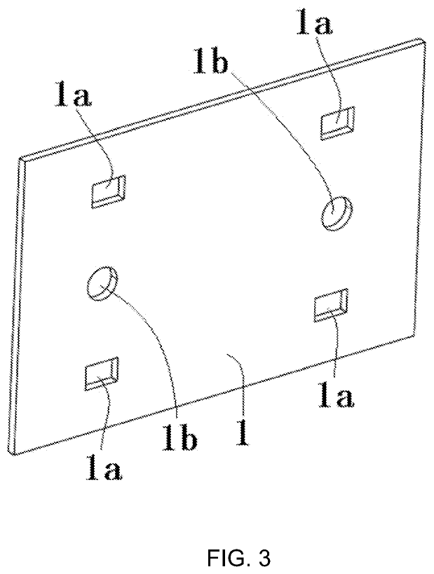

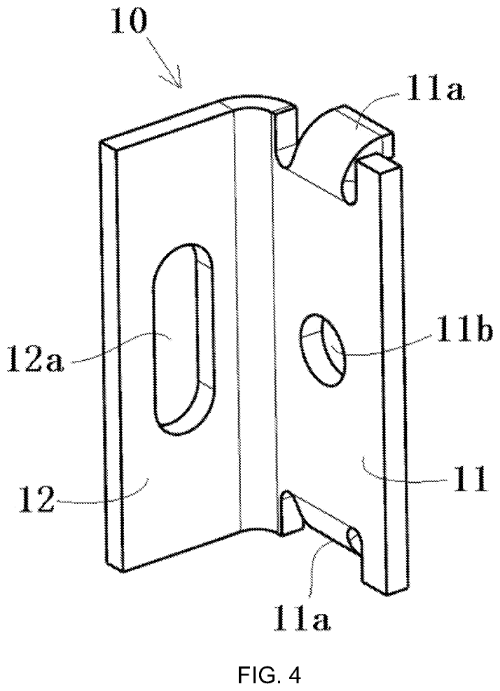

FIG. 3 illustrates a stereoscopic schematic view of the straight beam as illustrated in FIG. 1; FIG. 4 illustrates a stereoscopic schematic view of a shoe liner bracket of the elevator sliding guide shoe as illustrated in FIG. 2.

As illustrated in FIG. 3 and FIG. 4, in the illustrated embodiment, each shoe liner bracket 10 includes a base plate portion 11 and a side plate portion 12 perpendicular to the base plate portion 11. As illustrated in FIG. 1 to FIG. 4, the base plate portion 11 is used to be secured onto the straight beam 1. In the illustrated embodiment, each shoe liner bracket 10 is secured to the straight beam 1 by a single bolt 40. As such, the number of bolts 40 may be reduced, thereby reducing the time taken to disassemble and assemble the shoe liner bracket 10.

As illustrated in FIG. 3 and FIG. 4, in the illustrated embodiment, a first through-hole 11b which allows the bolt 40 to pass through is formed on the base plate portion 11 of the shoe liner bracket 10, and a second through-hole 1b which allows the bolt 40 to pass through is formed on the straight beam 1. As illustrated in FIG. 1, the bolt 40 passes through the first through-hole 11b and the second through-hole 1b, and is threadedly connected with a screw nut so as to fixedly mount the respective shoe liner bracket 10 onto the straight beam 1.

As illustrated in FIG. 3 and FIG. 4, in the illustrated embodiment, two positioning feet 11a are formed on respective base plate portion 11 of each shoe liner bracket 10, with each positioning foot 11a being formed at a respective one of an upper portion and a lower portion of respective base plate portion 11 of each shoe liner 10 respectively. Each positioning foot 11a is bent and adapted to be inserted into a respective socket 1a on the straight beam 1, so as to position the shoe liner bracket 10 and prevent the shoe liner bracket 10 from rotating. Therefore, when the bolt 40 is screwed to fix the shoe liner bracket 10, the positioning feet 11a on the upper portion and the lower portion of the shoe liner bracket 10 may reliably prevent the shoe liner bracket 10 from rotating around the bolt 40, and may also quickly position the shoe liner bracket 10.

However, the present disclosure is not limited to the illustrated embodiments, but also one bent positioning foot, or three or more bent positioning feet 11a may be formed on the base plate 11 of each shoe liner bracket 10. In addition, respective shapes of each positioning foot 11a and each socket 1a are not limited to the rectangular shapes as illustrated in the figure, but can also be in the form of circular shapes or other shapes.

As illustrated in FIG. 2 and FIG. 4, in the illustrated embodiment, a slot 12a is formed on the side plate portion 12 of each shoe liner bracket 10. Bump portions 22a are formed on respective outer surfaces of the pair of side walls 22 of the shoe liner 20. The bump portions 22a are inserted into respective slots 12a of the pair of shoe liner brackets so as to mount the shoe liner 20 to the pair of shoe liner brackets 10.

In the above embodiments, due to the split-type design of the elevator sliding guide shoe, the installation and maintenance process thereof is simple and flexible. An anti-rotation design of the shoe liner bracket reduces amount of fixing parts in use, reduces the material cost to a certain extent, and facilitates the installation of the shoe liner brackets. For the hoistway having relatively narrow space therein, the elevator sliding guide shoe of split-type design may reduce the situation where the quality of installation may not be guaranteed due to the small space and inconvenient usage of tools.

Although not illustrated, in another exemplary embodiment of the present disclosure, an elevator car is also disclosed. The elevator car includes the elevator sliding guide shoe as above, which is installed on the straight beam 1 of the elevator car (see FIG. 1 to FIG. 4), and is adapted to slide along a car guide rail fixed on a hoistway wall of the elevator.

Although not illustrated, in another exemplary embodiment of the present disclosure, an elevator counterweight is also disclosed. The elevator counterweight includes the elevator sliding guide shoe as above, which is installed on the straight beam 1 of the elevator car (see FIG. 1 to FIG. 4), and is adapted to slide along a counterweight guide rail on a hoistway wall of the elevator.

Those skilled in the art may understand that the embodiments described above are exemplary, and those skilled in the art may improve them. The structures as described in various embodiments may be freely combined in the absence of any structural or principle conflicts.

Although the present disclosure is described in view of the attached drawings, the embodiments disclosed in the attached drawings are intended to illustrate preferred embodiments of the present disclosure, but should not be understood as a limitation of the present disclosure.

Although some embodiments of the overall concept of the present disclosure have been illustrated and explained, those skilled in the art will understand that these embodiments may be changed without departing from the principles and spirit of the overall concept of the present disclosure. The scope of the present disclosure is defined by the claims and their equivalents.

It should be noted that the word “comprise/include” does not exclude other elements or steps, and the word “a/an” or “one” does not exclude more than one.

In accordance with the provisions of the patent statutes, the present invention has been described in what is considered to represent its preferred embodiment. However, it should be noted that the invention can be practiced otherwise than as specifically illustrated and described without departing from its spirit or scope.

1-10. (canceled)

11. An elevator sliding guide shoe comprising:
a pair of shoe liner brackets, each of the shoe liner brackets adapted to be detachably mounted on a straight beam of an elevator car or an elevator counterweight of an elevator;
a shoe liner adapted to be disposed between the shoe liner brackets, the shoe liner including a pair of side walls and a bottom wall between the side walls; and
wherein when each of the side walls of the shoe liner is detachably mounted on one of the shoe liner brackets and the shoe liner brackets are mounted on the straight beam with the shoe liner disposed between the shoe liner brackets, the shoe liner is detachable from the straight beam by detaching either one of shoe liner brackets from the straight beam.

12. The elevator sliding guide shoe according to claim 11 including at least one positioning foot formed on each of the shoe liner brackets, the at least one positioning foot being bent and adapted to be inserted into a socket of the straight beam to position the shoe liner brackets on the straight beam and prevent the shoe liner brackets from rotating relative to the straight beam.

13. The elevator sliding guide shoe according to claim 11 including two positioning feet formed on each of the shoe liner brackets, each of the positioning feet being formed at a respective one of an upper portion and a lower portion of the shoe liner brackets, and the positioning feet being bent and adapted to be inserted into corresponding sockets formed in the straight beam.

14. The elevator sliding guide shoe according to claim 13 wherein each of the shoe liner brackets has a base plate portion adapted to be secured onto the straight beam, and wherein the two positioning feet are formed on the base plate portion with one of the positioning feet at the upper portion and another of the positioning feet at the lower portion.

15. The elevator sliding guide shoe according to claim 14 wherein each of the shoe liner brackets has a side plate portion extending perpendicular to the base plate portion with a slot formed on the side plate portion, and including bump portions formed on outer surfaces of the side walls of the shoe liner, the bump portions being inserted into the slots of the shoe liner brackets to detachably mount the shoe liner to the shoe liner brackets.

16. The elevator sliding guide shoe according to claim 15 including a cushioning pad having side portions being clamped between the side walls of the shoe liner and the side plate portions of the shoe liner brackets, and the cushioning pad having a bottom portion clamped between the bottom wall of the shoe liner and the straight beam.

17. The elevator sliding guide shoe according to claim 14 wherein each of the shoe liner brackets is detachably secured to the straight beam by a single bolt.

18. The elevator sliding guide shoe according to claim 17 including a first through-hole formed on the base plate portion of each of the shoe liner brackets and an associated second through-hole formed on the straight beam, the first through-holes and the associated second through-holes receiving the bolts to mount the shoe liner brackets onto the straight beam.

19. An elevator car comprising:
a straight beam; and
the elevator sliding guide shoe according to claim 11 mounted on the straight beam and adapted to slide along a car guide rail fixed on a hoistway wall of an elevator.

20. An elevator counterweight comprising:
a straight beam;
the elevator sliding guide shoe according to claim 11 mounted on the straight beam and adapted to slide along a counterweight guide rail on a hoistway wall of an elevator.
